(19) United States
(12) Patent Application Publication
(10) Pub. No.: US 2025/0194644 A1
(43) Pub. Date: Jun. 19, 2025

(54) MIMICKING HEALTH BENEFITS OF PHYSICAL EXERCISE IN CATS

(71) Applicant: Société des Produits Nestlé S.A., vevey (CH)

(72) Inventors: Yuanlong Pan, Chesterfield, MO (US); Julie Kristine Spears, St. Louis, MO (US); Sandeep Bhatnagar, BALLWIN, MO (US); Hui Xu, Chesterfield, MO (US)

(73) Assignee: Société des Produits Nestlé S.A., vevey (CH)

(21) Appl. No.: 18/969,229

(22) Filed: Dec. 4, 2024

Related U.S. Application Data
(60) Provisional application No. 63/609,766, filed on Dec. 13, 2023.
(60) Provisional application No. 63/609,729, filed on Dec. 13, 2023.

(51) Int. Cl. A23K 20/147; A23K 50/42

(52) U.S. Cl. CPC A23K 20/147; A23K 50/42

(57) ABSTRACT

A method of mimicking health benefits of physical exercise in a cat can include administering a high protein diet to a cat, the high protein diet including from about 110% to about 350% of a Recommended Daily Allowance (RDA) of protein for the cat on a daily basis. The high protein diet in this example is sufficient to increase a 12,13-diHOME blood level for an 18-24 hour period per day compared to a baseline blood level without the need for physical exercise.

### CROSS REFERENCE TO RELATED APPLICATIONS

This application claims priority to U.S. Provisional application No. 63/609,766 filed Dec. 13, 2023 and U.S. Provisional application No. 63/609,729 filed Dec. 3, 2023, the disclosure of which is incorporated in its entirety herein by this reference.

### BACKGROUND

Physical exercise and other physical activity in animals, such as pets and humans, can improve the general health of the animal, including providing enhanced cardiovascular health, mental health, metabolic health, and life span/health span, and can also provide a reduced risk of many chronic diseases. For example, physical exercise, voluntary cold exposure, e.g., cold plunge, etc. can promote some of these health benefits via the production of certain lipokines. Some of these lipokines in the body may be generated in response to physical exercise and other physical activity. However, many animals, such as cats, tend to have lower blood levels of certain lipokines compared to more active animals. Increasing the blood levels of such compounds can increase mitochondrial biogenesis and fatty acid oxidation in skeletal muscle, and can also improve cardiac hemodynamics and mitochondrial respiration in skeletal muscle and cardiac muscle. As physical exercise or voluntary cold exposure, etc., have become more understood, the health concerns over animals that lead a more sedentary lifestyle have likewise become clearer. This can be a particular issue, for example, with animals that may not be able to exercise and/or may not be given the opportunity to exercise at no fault of their own. For example, a disabled person owning a companion animal may not be able to provide themselves or their pet a proper amount of exercise due to circumstance. Thus, it would be beneficial to provide a way for more sedentary cats to mimic, or in some cases even improve upon some of the health benefits of physical exercise.

### DETAILED DESCRIPTION

Lipokines, such as the oxylipin referred to as 12,13-dihydroxy-9Z-octadecenoic acid (or 12,13-diHOME), are bioactive compounds that have various signaling pathways in the bodies of animals, such as various pets, including cats. 12,13-diHOME in particular seems to be closely associated with improved cardiac and/or metabolic health, e.g., providing a positive impact on obesity and/or metabolic disease. Increasing blood levels of 12,13-diHOME can ameliorate some concerns associated with a sedentary way of life.

12,13-diHOME is typically derived from adipose tissue depots and can stimulate the browning process of white adipose tissue. 12,13-diHOME also appears to promote lipolysis of fats and other lipids, which relates to their breakdown by hydrolysis to release fatty acids. Additionally, 12,13-diHOME in the blood also appears to promote the absorption or uptake of fatty acids. In addition, this particular lipokine can also promote fatty acid oxidation and mitochondrial biogenesis. With this in mind, 12,13-diHOME appears to have a relatively significant impact on various health issues, which have been more closely associated with physical activity, such as physical exercise. For reference, an example structure of 12,13-diHOME is shown below as Formula I, as follows:

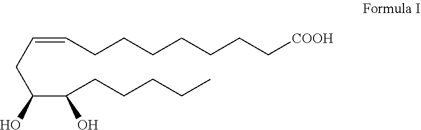 [SMILES: CCCCC[C@@H](O)[C@@H](O)C/C=C\CCCCCCCC(=O)O]

It has been recognized that rather than requiring physical exercise that can increase the circulating blood level of 12,13-diHOME, the adoption of a high protein diet can provide an alternative approach to the increase of 12,13-diHOME in the blood. Furthermore, in some examples, with a daily consistent high protein diet, these higher blood levels may be present with fewer peaks and troughs that are more closely associated with the production of 12,13-diHOME after physical exercise, for example. As the glucose response in cats can be fairly rapid with a quick insulin spike followed by stabilization in a matter of hours (based on a healthy cat), the introduction of a high protein modified diet can typically lead to a fairly stable metabolic response within most cats in just a few days. Thus, with the high protein diet described herein, relatively stable 12,13-diHOME blood levels can likewise be achieved typically within a few days, within a week, or within a month, for example, particularly if the high protein diet is administered daily on a consistent basis. In other words, when the 12,13-diHOME blood levels might otherwise start to drop, e.g., within several hours after exercise, the high protein diet described herein can continue to provide blood levels of the 12,13-diHOME for more extended periods of time, e.g., from about 18 hours to about 24 hours per day, thus promoting enhanced metabolic health even without the need for physical exercise.

More specifically, in accordance with the present disclosure, by administering a high protein diet that exceeds the Recommended Daily Allowance (RDA) to a cat, the blood levels of 12,13-diHOME can be increased compared to a baseline blood level measured prior to the high protein diet beginning. For example, administering a high protein diet to a cat of from about 110% to about 350% of the RDA of protein for that specific cat, can increase the blood levels of 12,13-diHOME in the cat for an 18-24 hours period per day compared to a baseline blood level, and this is accomplished without the need for physical exercise. Thus, the high protein diet described herein can deliver health benefits similar to those of physical exercise in cats, and in most instances, provide an even more sustained blood level of 12,13-diHOME compared to physical activity.

In greater detail, in some examples, the high protein diet can include from about 110% to about 300% of the RDA of protein and the increased 12,13-diHOME blood level is maintained over the 18-24 hour period compared to the baseline blood level. In other examples, the high protein diet includes from about 150% to about 250% of the RDA of protein and the 12,13-diHOME blood level is increased over the 18-24 hour period compared to the baseline blood level and, in some examples, can be maintained or increased over the 18-24 hour period without the cat engaging in physical exercise. In some examples, after about 3 days on the high protein diet, the 12,13-diHOME blood level may be increased compared to a baseline blood level for a full 24 hours per day. In further detail, administering to the cat the high protein diet can include administering the high protein diet on daily consistent basis for a period of time of at least one (1) week, at least two (2) weeks, or at least one (1) month, e.g., from 3 days to 1 year, from 3 days to 6 months, from 3 days to 2 months, from 3 days to 1 month, from 1 week to 1 year, from 1 week to 6 months, from 1 week to 2 months, from 1 week to 1 month, from 1 month to 1 year, from 1 month to 6 months, or from 1 month to 2 months. In one example, administering can be on a regular basis and/or a long-term administration.

The RDA of protein for the adult cat can be established at 26 wt % based on 100% of a Maintenance Energy Requirement (MER) for the cat, and the high protein diet can include administering a cat food on a daily basis containing from about 30 wt % to about 75 wt % protein calculated based on the 100% of the MER for the cat. In other examples, the high protein diet can include administering a cat food on a daily basis containing from about 35 wt % to about 75 wt % protein calculated based on the 100% of the MER for the cat. In other examples, the high protein diet can include administering a cat food on a daily basis containing from about 40 wt % to about 60 wt % protein calculated based on the 100% of the MER for the cat. In some examples, the increase in protein can be administered or fed to the cat via a decreased caloric intake diet or an increased caloric intake diet, either of which can be used to mimic the health benefits of physical exercise. For example, administering a decreased caloric intake diet having from about 50% to about 95% of the MER for the cat can still result in increasing 12,13-diHOME blood levels in the cat. With respect to administering a decreased caloric intake diet to the cat, the protein content may be calculated so that the cat still receives an equivalent of the about 35 wt % to about 75 wt % protein based on the 100% of the MER With respect to administering an increased caloric intake diet to the cat at from about 105% to 200% of the MER for the cat, the protein content may be calculated so that the cat receives an equivalent of the about 35 wt % to about 75 wt % protein based on the 100% of the MER. Administration (or feeding) of the cat food to the cat can occur once per day, or can occur two to six times per day, provided the total protein administered by the cat is at an increased level relative to the RDA for protein. This feeding protocol for cats can be particularly beneficial for cats that may not get enough physical exercise. In accordance with this, a cat that may experience limited to no physical activity may be defined herein to include cats that do not engage in more than one day per week on average in exercise, or less than about 30 minutes of exercise per week. Examples include cats serving as companion animals, an indoor pet, a pet with a disability, etc.

In accordance with this, it is noted that when discussing examples related to the methods of mimicking health benefits of physical exercise in cats, such discussions can be considered applicable to other related examples that are not specifically explicitly discussed in the context of that example. For example, when discussing “high protein diet” in the context of the methods herein, such disclosure can also be related to systems and/or compositions for achieving high protein diets in cats. Furthermore, terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

To exemplify how the Recommended Daily Allowance (RDA) of protein correlates with the daily Maintenance Energy Requirement (MER) for adult cats, it is noted that the RDA of protein (recommended for adult cat food) is currently 26 wt % and the RDA is achieved for the adult cat when the cat is fed 100% of its Maintenance Energy Requirement (MER) per day. In accordance with the present disclosure, by increasing the protein content to from about 30 wt % to about 75 wt % (based on a calculated 100% MER for that particular cat), the 12,13-diHOME blood levels can be increased over the baseline blood levels. On the other hand, to increase blood levels of 12,13-diHOME in the cat by about a 2-fold factor or more, the high protein diet may be administered as a cat food on a daily basis which contains from about 35 wt % to about 75 wt % protein (based on a calculated 100% MER for that particular cat). In other examples, the high protein diet can include administering a cat food on a daily basis containing from about 40 wt % to about 75 wt % protein calculated based on the 100% of the MER for the cat. These increased levels of 12,13-diHOME are relative to the baseline blood level that can be collected prior to starting the diet modification.

Regarding the reduced caloric intake diet in particular, there may be instances where a cat is fed less than or more than its 100% Maintenance Energy Requirement (MER), such as for dieting or for other heath or medical purposes. For example, a cat may be administered from about 50% to about 95% of its MER if under a lower calorie diet. In such instances, the cat food could be formulated to include an equivalent of about 30 wt % to about 75 wt % protein, about 35 wt % to about 75 wt % protein, or about 40 wt % to about 75 wt % protein (for increasing blood levels of 12,13-diHOME) as calculated based on its 100% MER, even though the total calories being fed to the cat would be less than its daily MER. To illustrate by way of example, if a cat is fed 60% of its daily MER, using 100% MER as a basis to calculate how much protein content should be present in the cat food, the equivalent of 26 wt % protein (at 100% MER) in the cat food would be about 43.3 wt % protein, meaning that at least 43.3 wt % protein should be present in the cat food if the cat is being fed 60% of its daily MER. As the upper end of the range in this example is 75 wt % (based on its full MER), the protein content would exceed 100 wt %, and thus at a 60% MER diet, the protein content in the food would cap out at 100 wt % protein. In other words, if feeding a cat 60% of its MER, the range of protein content in the cat food may more practically range from about 40 wt % to about 75 wt %. Similar calculations can be carried out when feeding the cat at 50% to 90% of MER, e.g., 50% MER, 75% MER, 90% MER, etc.

In one embodiment, the diet can produce greater than a 2-fold increase in 12,13-diHOME blood levels in cats, e.g., at 161% MER and a cat food containing 36.3 wt % protein, a 2.24-fold increase in 12,13-diHOME blood levels has been shown. Likewise, to increase blood levels of 12,13-diHOME in the cat by about 3-fold (2.99-fold as shown in data) or more, a cat can be administered about 200% of its RDA for protein. For example, at 110% MER, a cat food containing 48.7 wt % protein, a 2.99-fold increase in 12,13-diHOME blood levels has been shown

To determine the baseline blood level so that the increase in blood levels may be determined, blood analysis of a cat is taken in a cat that has not exercised that day and has been fed its 100% of its daily MER of cat food containing at least 26 wt % protein, which is the percentage representing the RDA of protein for adult cats. The increased blood levels can be obtained at about 24 hours after the cat receives its daily meal (or 24 hours after its first daily meal if the cat is fed twice per day), just prior to the meal offered the next day (if feeding once per day). If feeding more than once per day, the data can be collected just prior to the first meal of the day. The increased blood levels can be obtained at about 24 hours after the cat receives its daily meal (or 24 hours after its first daily meal if the cat is fed two or three times per day), just prior to the meal offered the next day. To obtain more consistent levels of enhanced levels 12,13-diHOME, it may take a few days, a week, two weeks, or a month of the daily high protein diet before the benefits are fully realized, depending on the cat. However, similar to how the baseline blood level is measured, the blood level may be measured by sampling blood 24 hours after the cat receives its daily meal, which shows not only increased levels of the 12,13-diHOME in the blood, but also shows that the blood levels may be more stable than that which occurs with physical exercise.

The food compositions disclosed herein can be any food formulated for consumption by an animal. In one embodiment, the food compositions can be pet food compositions. In one aspect, the pet food compositions can be formulated for a canine. In an embodiment, the pet food composition provides complete nutrition as defined by the Association of American Feed Control Officials (AAFCO) and which depends on the type of animal for which the composition is intended (e.g., a cat).

In addition to the above, in some embodiments, the food compositions can comprise protein in amounts from about 30%, 35%, 40%, 45%, 50%, 55%, 60%, or even 65% to about 35%, 40%, 45%, 50%, 55%, 60%, 65%, 70%, 75%, 80%, 85%, or even 90% by weight, including various subranges within these amounts. In one aspect, the protein can be from about 30% to about 60% of the food composition by weight.

The food composition can comprise meat, such as emulsified meat. Examples of suitable meat include poultry, beef, pork, lamb and fish, especially those types of meats suitable for pets. The meat can include any additional parts of an animal including offal. Some or all of the meat can be provided as one or more meat meals, namely meat that has been dried and ground to form substantially uniform-sized particles and as defined by AAFCO. Additionally or alternatively, plant protein can be used, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like.

In one embodiment, the food compositions can comprise fat in amounts from about 5%, 10%, 15%, 20%, 25%, 30%, 35%, 40%, 45%, or even 50% to about 15%, 20%, 25%, 30%, 35%, 40%, 45%, 50%, 55%, or even 60%, including various subranges within these amounts by weight. In one aspect, the fat comprises from about 10% to about 40% of the food composition by weight.

The food compositions disclosed herein can comprise one or more of a vegetable oil, a flavorant, a colorant or water. Non-limiting examples of suitable vegetable oils include soybean oil, corn oil, cottonseed oil, sunflower oil, canola oil, peanut oil, safflower oil and the like. In some embodiments, the lipids in the composition can include medium chain triglycerides and one or more of any vegetable oil, any fish oil, the lipid from any meat, and any omega-3 fatty acids.

Non-limiting examples of suitable flavorants include yeast, tallow, rendered animal meals (e.g., poultry, beef, lamb, pork), flavor extracts or blends (e.g., grilled beef), animal digests, and the like. Non-limiting examples of suitable colorants include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

The food compositions disclosed herein can optionally include additional ingredients, such as starches, humectants, oral care ingredients, preservatives, amino acids, fibers, prebiotics, sugars, animal oils, aromas, other oils additionally or alternatively to vegetable oil, salts, vitamins, minerals, probiotic microorganisms, bioactive molecules or combinations thereof.

In one embodiment, the carbohydrate comprises from about 1% to about 70% of the food composition by weight. In another embodiment, the carbohydrate comprises from about 20% to about 60% of the food compositions by weight. In other aspects, the carbohydrate can be present in amounts from about 1%, 5%, 10%, 20%, 30%, 40%, or even 50%, to about 5%, 10%, 20%, 30%, 40%, 50%, 60%, or even 70% by weight.

Non-limiting examples of suitable starches include a grain such as corn, rice, wheat, barley, oats, potatoes, peas, beans, cassava, and the like, and mixtures of these grains, and can be included at least partially in any flour. Non-limiting examples of suitable humectants include salt, sugars, propylene glycol and polyhydric glycols such as glycerin and sorbitol, and the like. Non-limiting examples of suitable oral care ingredients include alfalfa nutrient concentrate containing chlorophyll, sodium bicarbonate, phosphates (e.g., tricalcium phosphate, acid pyrophosphates, tetrasodium pyrophosphate, metaphosphates, and orthophosphates), peppermint, cloves, parsley, ginger and the like. Non-limiting examples of suitable preservatives include potassium sorbate, sorbic acid, sodium methyl para-hydroxybenzoate, calcium propionate, propionic acid, and combinations thereof.

Specific amounts for each additional ingredient in the food compositions disclosed herein will depend on a variety of factors such as the ingredient included in the first edible material and any second edible material; the species of animal; the animal's age, body weight, general health, sex, and diet; the animal's consumption rate; the purpose for which the food product is administered to the animal; and the like. Therefore, the components and their amounts may vary widely.

Yet another aspect of the present disclosure is a method of making a pet food, the method comprising combining any of the comestible ingredients described above, mixing the ingredients, extruding the mixture, optionally, drying the extrudate, and optionally cutting or breaking the extrudate into individual kibbles.

In one embodiment, the composition can comprise arginine, eicosapentaenoic acid, docosahexaenoic acid, vitamin E, and B vitamins. Such B vitamins can include any combination of vitamin B1 (thiamine), vitamin B2 (riboflavin), vitamin B3 (niacin, nicotinic acid, nicotinamide), vitamin B5 (pantothenic acid), vitamin B6 (pyridoxine, pyridoxal, pyridoxamine), vitamin B7 (biotin), vitamin B8 (myo-inositol), vitamin B9 (folic acid) vitamin B12 (cobalamin compounds including methylcobalamin, hydroxocobalamin, and cyanocobalamin).

Generally, the composition can be administered sufficiently such that the 12,13-diHOME is increased to a desired level. In one aspect, the administration can be on a regular basis. In another aspect, the administration can be a long-term administration. Administration of the composition can include any manner of delivery. In one embodiment, the composition can be administered in conjunction with a food composition. In another embodiment, the composition is a pet food. In still another embodiment, the composition can be a sachet or supplement administered in conjunction with a food. In yet another embodiment, the composition can be a sachet or supplement administered separately from other food compositions.

Additionally, the present compositions can comprise omega-3 fatty acids. Non-limiting examples of suitable omega-3 fatty acids include eicosapentaenoic acid (EPA), docosahexaenoic acid (DHA), alpha-linolenic acid (ALA) and mixtures thereof. In one embodiment, the omega-3 fatty acids can range from about 0.2%, 0.5%, 1%, 2%, or even 3% to about 1%, 2%, 3%, 4%, or even 5% of the composition by weight. In some embodiments, the omega-3 fatty acids are present in the food composition in an amount from about 0.7% to about 5% by weight. In some embodiments, the omega-3 fatty acids are present in the food composition in an amount from about 0.30% to about 2% by weight.

In addition to the fats and fatty acids discussed herein, the present compositions can comprise omega-6 fatty acids. Non-limiting examples of suitable omega-6 fatty acids include linoleic acid, gamma-linolenic acid (GLA), arachidonic acid (AA, ARA), eicosadienoic acid, docosadienoic acid, and mixtures thereof. In one embodiment, the omega-6 fatty acids can range from about 0.2%, 0.5%, 1%, 2%, or even 3% to about 1%, 2%, 3%, 4%, or even 5% of the composition by weight. In some embodiments, the omega-6 fatty acids are present in the food composition in an amount from about 1% to about 5% by weight. In some embodiments, the omega-6 fatty acids are present in the food composition in an amount from about 1% to about 2% by weight.

According to the presently described methods, administration, including administration as part of a dietary regimen, can span a period ranging from parturition through the adult life of the animal. In certain embodiments, the animal can be a young or growing animal. In other embodiments, administration can begin, for example, on a regular or extended regular basis, when the animal has reached more than about 10%, 20%, 30%, 40%, or 50% of its projected or anticipated lifespan. In some embodiments, the animal can have attained 40, 45, or 50% of its anticipated lifespan. In yet other embodiments, the animal can be older having reached 60, 66, 70, 75, or 80% of its likely lifespan. A determination of lifespan may be based on actuarial tables, calculations, estimates, or the like, and may consider past, present, and future influences or factors that are known to positively or negatively affect lifespan. Consideration of species, gender, size, genetic factors, environmental factors and stressors, present and past health status, past and present nutritional status, stressors, and the like may also influence or be taken into consideration when determining lifespan

### Example Embodiments

In accordance with the disclosure herein, the following examples are illustrative of several embodiments of the present technology.

1. A method of mimicking health benefits of physical exercise in a cat, comprising administering a high protein diet to a cat, the high protein diet including from about 110% to about 350% of a Recommended Daily Allowance (RDA) of protein for the cat on a daily basis, wherein the high protein diet is sufficient to increase a 12,13-diHOME blood level for an 18-24 hour period per day compared to a baseline blood level without the need for physical exercise.

2. The method of claim 1, wherein the high protein diet includes from about 150% to about 250% of the RDA of protein and the 12,13-diHOME blood level is increased by at least 2-fold over the 18-24 hour period compared to the baseline blood level.

3. The method of any of claims 1-2, wherein the 12,13-diHOME blood level is higher over the 18-24 hour period compared to the baseline blood level without the cat engaging in physical exercise.

4. The method of any of claims 1-3, wherein the RDA of protein for the adult cat is 26 wt % based on 100% of a MER for the cat, and wherein the high protein diet includes administering a cat food on a daily basis containing from about 30 wt % to about 75 wt % protein calculated based on the 100% of the MER for the cat.

5. The method of any of claims 1-4, further comprising administering a decreased caloric intake diet having from about 50% to about 95% of the MER for the cat, wherein the cat food still includes an equivalent of the about 40 wt % to about 75 wt % protein calculated based on the 100% of the MER.

6. The method of any of claims 1-4, further comprising administering an increased caloric intake diet having from about 105% to about 200% of the MER for the cat, wherein the cat food still includes an equivalent of the about 35 wt % to about 70 wt % protein calculated based on the 100% of the MER.

7. The method of any of claims 1-6, wherein administering the high protein diet to the cat includes administering the cat food on a daily basis containing from about 35 wt % to about 75 wt % protein calculated based on the 100% of the MER for the cat.

8. The method of any of claims 1-7, wherein administering the high protein diet to the cat occurs by feeding the cat once per day.

9. The method of any of claims 1-8, wherein administering the high protein diet to the cat occurs by feeding the cat two to six times per day.

10. The method of any of claims 1-9, wherein the cat is a companion animal that does not experience physical exercise on more than about one day per week on average.

11. The method of any of claims 1-10, wherein the cat is the companion animal to a caregiver that is sedentary or disabled.

12. The method of any of claims 1-11, wherein the cat has a disability that diminishes the ability of regular physical exercise.

13. The method of any of claims 1-12, wherein after about 3 days on the high protein diet, the 12,13-diHOME blood level is increased compared to a baseline blood level for a full 24 hours per day.

14. The method of any of claims 1-13, wherein administering to the cat the high protein diet includes administering the high protein diet on daily consistent basis for a period of time of at least 1 week.

### Definitions

The terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

The term “animal” means any animal that has a need for the health benefits disclosed herein, including mammals, such as human, avian, bovine, canine, equine, feline, hircine, lupine, murine, ovine, or porcine animals.

The term “companion animal” means a dog or a cat. As used herein, the term “cat” and “feline” can be used interchangeably. In one embodiment, the companion animal can be a cat.

The term “complete and balanced” when referring to a food composition means a food composition that contains all known required nutrients in appropriate amounts and proportions based on recommendations of recognized authorities in the field of animal nutrition, and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO) as of Jan. 1, 2023.

As used herein, “comprising” or “including” language or other open-ended language can be substituted with “consisting essentially of” and “consisting of” as if such transition phrase is expressly included in such embodiments.

The term “long-term administration” means periods of repeated administration or consumption in excess of one month. Periods of longer than two, three, or four months can be used for certain embodiments. Also, more extended periods can be used that include longer than 5, 6, 7, 8, 9, or 10 months. Periods in excess of 11 months or 1 year can also be used. Longer term use extending over 1, 2, 3, or more years are included in the invention. For certain aging animals, the animal will continue consuming on a regular basis for the remainder of its life. This can also be referred to as consumption for “extended” periods.

The term “regular basis” means at least monthly dosing with the compositions or consumption of the compositions, and in one aspect, means at least weekly dosing. More frequent dosing or consumption, such as twice or three times weekly, can be performed in certain embodiments. Still, in other embodiments, regimens can be used that comprise at least once daily consumption.

The term “about” refers to values similar to specifically enumerated numbers with some flexibility that would not substantially alter the function of the benefit achieved by the value(s) provided. For example, the term “about” can refer to the recited number plus or minus 10%, plus or minus 5%, plus or minus 3%, or plus or minus 1%. To illustrate, the term “about” when interpreted as being plus or minus 5% of a numeric range, such as “from about 1 cm to about 2 cm,” would be interpreted as including a range from 9.5 mm to 2.1 cm, from 1.05 cm to 1.9 cm, from 9.5 mm to 1.9 cm, or 1.05 cm to 2.1 cm. Similar calculations for any of the other individual numerical values or individual parameters of numerical ranges set forth herein can be modified similarly such that the “about” modifier fully supports subranges including +/−3% or +/−1% of the numerical value provided.

All percentages expressed herein are by weight (wt %) of the composition on a dry matter basis unless specifically stated otherwise. The skilled artisan will appreciate that the term “dry matter basis” means that an ingredient's concentration or percentage in a composition is measured or determined after any free moisture in the composition has been removed. When reference is made to the pH, values correspond to pH measured at 25° C. with standard equipment. An “amount” can be the total amount of the referenced component per serving of the composition or per distinct unit of the composition and/or can be the weight percentage of the referenced component by dry weight. Moreover, an “amount” includes zero; for example, the recitation of an amount of a compound does not necessarily mean that the compound is present, unless followed by a range that excludes zero.

As used herein, ranges are in shorthand so as to avoid having to list and describe each and every value within the range. Any appropriate value within the range can be selected, where appropriate, as the upper value, lower value, or the terminus of the range, and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting one numerical value. Furthermore, such an interpretation should apply regardless of the breadth of the range or the characteristics being described.

The term “example(s)” or “embodiment(s),” such as when followed by a listing of terms or when giving a specific illustration including details of a single or multiple parameters is merely illustrative and should not be deemed to be exclusive or comprehensive.

The methods and any compositions disclosed herein are not limited to particular methodology, protocols, reagents, etc., described herein because, as the skilled artisan will appreciate, they may vary. Further, the terminology used herein is for the purpose of describing particular embodiments only, and is not intended to and does not limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, certain compositions, methods, articles of manufacture, or other means or materials are described herein.

As used herein, a plurality of elements, compositional components, and/or materials may be presented in a common list for convenience. However, these lists should be construed as though individual members of the list are individually identified as separate and unique members. Thus, no individual member of such list should be construed as a de facto equivalent of any other member of the same list solely based on presentation in a common group without indications to the contrary.

### EXAMPLES

Features of the present disclosure are illustrated by the following examples, although it will be understood that these examples are included merely for purposes of illustration and are not intended to limit the scope of the invention.

### Example 1—Six (6) Month Enhanced Protein Cat Study with Decreased Caloric Intake

Thirty (30) adult cats were randomized into two groups of 15 cats, providing a control group of 15 cats and a high protein group of 15 cats. In evaluating the cats in the study, data was collected based on several criteria, including baseline Maintenance Energy Requirement (MERs), which takes into account the cats' age, whether the cat has been neutered, weight, size, activity level, body condition score, percent (%) body fat, etc. The baseline MERs can be established using criteria from the MER Calculator for Cats from the Purina® Institute, which provides the estimated daily caloric needs of the cat. In determining the MERs for the individual cats, the body condition score may be established using the Body Condition System from the Purina institute, which is based on a scale of 1-9 (ranging from a score of 1 where the cat exhibits ribs, lumbar vertebrae, pelvic bones and all bony prominences evident from a distance; no discernible body fat; and obvious loss of muscle mass—to a score of 9 where the cat exhibits massive fat deposits over the thorax, spine, and base of tail; waist and abdominal tuck absent; fat deposits on the neck and limbs; and obvious abdominal distention). After establishing the baseline at Day 0, throughout the balance of the study, the cats were taken off of their exercise regimen.

Once the baseline was established, the daily caloric needs for each cat were determined based on the MERs for the cats, all 30 cats were fed 100% of their baseline MERs (or 100% of their daily caloric needs) using the control food containing 36.3 wt % protein. After feeding the cats at 100% of their baseline MERS, the cats in both groups were then fed at 75% of their MERs for four (4) months followed by 60% of their MERs for two (2) months, with the 15 cats in the control group continuing to receive the Control Diet (at the lower level relative to their baseline MERs), and the 15 cats in the study group receiving a High Protein Diet (again at the lower levels relative to their baseline MERs). Thus, the cat food of the Control Diet had a protein content of 36.3 wt %, so at 60% of the amount of cat food offered based on a typical 26 wt % protein content, the percent of dietary protein offered to the cats was calculated to be about 84% of the RDA for protein. Furthermore, the individual cats receiving the High Protein Diet were offered cat food with a protein content of 48.7 wt %, so at 60% of the amount of cat food offered based on a typical 26 wt % protein content, the percent of dietary protein offered to the cats was calculated to be about 112% of the RDA for protein.

In short, the cats were fed 100% of their maintenance energy requirements (MERs) at baseline with the control diet (Table 1), and then the cats in both groups were then fed at 75% of their MERs for four (4) months followed by 60% of their MERs for two (2) months. Table 2 summarizes the percentage of protein offered in the cat food of both groups, along with a calculated percentage of dietary protein relative to the Recommended Daily Allowance (RDA) for adult cats.

TABLE 1
Weight Percent (wt %) Protein and Percent (%) RDA of
Protein at baseline (at 100% MER)

| Diets | wt % Protein (DM*) | % RDA Protein** |
|---|---|---|
| Control Diet | 36.3 | 140 |
| Control Diet | 36.3 | 140 |

*Dry Matter
**Percentage based on RDA of 26 wt % Protein at 100% MER Feeding

TABLE 2
Weight Percent (wt %) Protein and Percent (%)
RDA of Protein at 60% of MER

| | wt % Protein | % RDA Protein |
|---|---|---|
| Diets | (DM*) | (60% MER Feeding)** |
| Control Diet | 36.3 | 84 |
| High Protein Diet | 48.7 | 112 |

*Dry Matter
**Percentage based on RDA of 26 wt % Protein at 60% MER Feeding

### Example 2—Metabolomic Data of Control Diet vs. High Protein Diet

Using the two groups of cats as described in Example 1, blood samples were collected to establish a blood baseline for each cat for both groups, and then blood samples were again taken after six (6) months, e.g., Month 6. Blood samples were collected 24 hours after the feeding of the diets. The blood samples were subjected to metabolomic analyses to measure 12,13-diHOME blood levels, and the data is provided in Table 3, as follows:

TABLE 3
12,13-diHOME Blood Levels†

| | Control Diet | | High Protein Diet | |
|---|---|---|---|---|
| | (area-under-the-curve) | | (area-under-the-curve) | |
| | Baseline (Day 0) | Month 6 | Baseline (Day 0) | Month 6 |
| 12,13-diHOME | 1.2941 | 0.3662 | 1.155 | 1.608 |

†Serum levels measured about 24 hours after meal (prior to next daily meal)

As can be seen in Table 3, the metabolomic data collected showed that with a daily dietary protein content set at 84% RDA (without significant physical exercise), there was a significant decrease in 12,13 diHOME at Month 6 compared to the baseline 12,13-diHOME blood levels, which were obtained with a 140% RDA protein. Thus, providing the cats with 84% RDA of protein resulted in a 71.7% decrease in 12,13-diHOME blood levels as compared to feeding cats 140% RDA protein, e.g., 0.3662/1.2941=28.3. Also, increasing protein generally correlated with higher 12,13-diHOME blood levels (compare 6-month high protein of 1.608 to both baseline control and 6-month control of 1.2941 and 0.3662). Unexpectedly, the cats in the high protein group that were provided with cat food at 112% RDA of protein (even when provided fewer calories 60% MER and lower % RDA protein—112%) experienced a significant increase in the average blood levels of 12,13-diHOME over the baseline control which was 100% MER and 140% RDA protein (1.608 vs 1.2941). Without being bound by any particular theory, the present inventor notes that the ratio of protein to carbohydrates was significantly different between the two diets as shown in Table 4.

TABLE 4

| Cat Study | Protein to Carb Ratio |
|---|---|
| Control | 1.41:1 |
| High Protein | 4:1 |

Such ratios indicate that the 12,13-diHOME blood levels in cats may be additionally modulated by protein to carbohydrate ratios as well as the high protein diet. As such, in one embodiment, the present methods can include utilizing a protein to carbohydrate ratio of at least 2:1, 3:1, or even 4:1 by weight. Additionally, the effects of high protein are unexpectedly potentiated by caloric deficiency because identical caloric deficiency failed to rescue the sharp decline of the lipokine in the cats fed the control diet which provided only about 84% of RDA of protein for adult cats.

### Example 3—Six (6) Month Enhanced Protein Cat Study with Increased Caloric Intake

The thirty (30) adult cats used in the Decreased Caloric Intake study of Examples 1 and 2 were switched to an Increased Caloric Intake study. The cats were fed the same diet as described in Examples 1 and 2, except that rather than the cats receiving 60% MERs (compared to the baseline), the cats received 115% of the cats' baseline MERs. The other parameters were the same, as outlined in Example 1.

Tables 5 and 6 summarize the percentage of protein offered in the cat food of both groups, along with a calculated percentage of dietary protein relative to the Recommended Daily Allowance (RDA) for cats.

TABLE 5
Weight Percent (wt %) Protein and Percent (%) RDA
of Protein at baseline (at 60% MER)

| Diets | wt % Protein (DM*) | % RDA Protein** |
|---|---|---|
| Control Diet | 36.3 | 84 |
| High Protein Diet | 48.7 | 112 |

*Dry Matter
**Percentage based on RDA of 26 wt % Protein at 60% MER Feeding

TABLE 6
Weight Percent (wt %) Protein and Percent (%) RDA of
Protein at 115% MER

| | wt % Protein | % RDA Protein |
|---|---|---|
| Diets | (DM*) | (115% MER Feeding)** |
| Control Diet | 36.3 | 161 |
| High Protein Diet | 48.7 | 215 |

*Dry Matter
**Percentage based on RDA of 26 wt % Protein at 115% MER Feeding

### Example 4—Metabolomic Data of Control Diet vs. High Protein Diet

Using the two groups of cats as described in Example 3, blood samples were collected to establish a baseline for each cat for both groups, and then blood samples were again taken six months later at Month 6. Blood samples were collected 24 hours after the feeding of the diets. The blood samples were subjected to metabolomic analyses to measure 12,13-diHOME blood levels, and the data is provided in Table 7, as follows:

TABLE 7
12,13-diHOME Blood Levels†

| | Control Diet | | High Protein Diet | |
|---|---|---|---|---|
| | (area-under-the-curve) | | (area-under-the-curve) | |
| | Baseline (Day 0) | Month 6 | Baseline (Day 0) | Month 6 |
| 12,13-diHOME | 0.5047 | 1.1221 | 1.3534 | 4.047 |

†Blood levels measured about 24 hours after meal (just prior to the next daily meal)

As can be seen in Table 7, the metabolomic data collected showed that with a daily dietary protein content set at 161% RDA (without physical exercise), there was an increase in 12,13-diHOME at Month 6 compared to the 12,13-diHOME blood levels at the baseline. For example, at 161% RDA of protein, the 12,13-diHOME blood levels increased across the population of cats of the Control Group, e.g., 1.1221/0.5047=2.22-fold increase. On the other hand, the cats in the high protein group that were provided with cat food at 215% RDA of protein experienced an even more significant increase in the average blood levels of 12,13-diHOME, even without any physical exercise. More specifically, the cats in the high protein group that were offered the high protein diet exhibited a 2.99-fold increase in 12,13-diHOME compared to their baseline blood levels, e.g., 4.047/1.3534=2.99-fold increase.

### Example 5—Data Analysis

The results from the two high protein studies, namely the study of Examples 1 and 2 and the study of Examples 3 and 4, indicated that, without any physical exercise or other activity that may otherwise increase 12,13-diHOME blood levels, the cats that were fed a 84% RDA of dietary protein did not maintain the blood levels of 12,13-diHOME compared to the blood baseline, and such lowering of dietary protein exhibited dramatically lowers levels of 12,13-diHOME in their blood, e.g., levels reduced by 71.7% compared to baseline as shown in Example 2. However, by increasing the dietary protein to at least about 110% RDA with a protein to carbohydrate ratio of at least 2:1, the blood levels of the 12,13-diHOME could be increased over the blood baseline. For example. Example 2 showed a 1.44-fold increase by providing 112% of RDA protein (even on a reduced caloric intake diet) over a diet having a 140% of RDA protein, but had a higher protein to carbohydrate ratio (compare 4:1 to 1.41:1). Example 4 showed more significant increases in 12,13-diHOME, with a 2.22-fold increase by providing 161% of RDA protein and a 2.99-fold increase by providing 215% of RDA protein to the cats. Based on this data, it has been found that feeding a cat at least about 110% RDA of protein can increase the blood levels of 12,13-diHOME in blood with a protein to carbohydrate ratio of at least 2:1, and feeding the cat at least about 140% RDA of protein can typically increase the blood levels of 12,13-diHOME in blood by at least about 2-fold, thus mimicking some of the health benefits associated with physical exercise, e.g., 161% RDA=2.22-fold increase and 215% RDA=2.99-fold increase.

It is also noted that the increased blood levels of 12,13-diHOME can be obtained, regardless of whether the cat was underfed with a Decreased Caloric Intake (as in Examples 1-2) or overfed with an Increased Caloric Intake (Examples 3-4), provided the cat receives enough protein to exceed the RDA. This indicates that the total calories fed to the cat do not prevent the upregulation of the 12,13-diHOME in the blood.

In the specification, there have been disclosed certain embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims, the invention may be practiced otherwise than as specifically described.

What is claimed is:

1. A method of mimicking health benefits of physical exercise in a cat, comprising administering a high protein diet to a cat, the high protein diet including from about 110% to about 350% of a Recommended Daily Allowance (RDA) of protein for the cat on a daily basis, wherein the high protein diet is sufficient to increase a 12,13-diHOME blood level for an 18-24 hour period per day compared to a baseline blood level without the need for physical exercise.

2. The method of claim 1, wherein the high protein diet includes from about 150% to about 250% of the RDA of protein and the 12,13-diHOME blood level is increased by at least 2-fold over the 18-24 hour period compared to the baseline blood level.

3. The method of claim 1, wherein the 12,13-diHOME blood level is higher over the 18-24 hour period compared to the baseline blood level without the cat engaging in physical exercise.

4. The method of claim 1, wherein the RDA of protein for the cat is 26 wt % based on 100% of a MER for the cat, and wherein the high protein diet includes administering a cat food on a daily basis containing from about 30 wt % to about 75 wt % protein calculated based on the 100% of the MER for the cat.

5. The method of claim 4, further comprising administering a decreased caloric intake diet having from about 50% to about 95% of the MER for the cat, wherein the cat food still includes an equivalent of the about 40 wt % to about 75 wt % protein calculated based on the 100% of the MER.

6. The method of claim 4, further comprising administering an increased caloric intake diet having from about 105% to about 200% of the MER for the cat, wherein the cat food still includes an equivalent of the about 35 wt % to about 70 wt % protein calculated based on the 100% of the MER.

7. The method of claim 4, wherein administering the high protein diet to the cat includes administering the cat food on a daily basis containing from about 35 wt % to about 75 wt % protein calculated based on the 100% of the MER for the cat.

8. The method of claim 1, wherein administering the high protein diet to the cat occurs by feeding the cat once per day.

9. The method of claim 1, wherein administering the high protein diet to the cat occurs by feeding the cat two to six times per day.

10. The method of claim 1, wherein the cat is a companion animal that does not experience physical exercise on more than about one day per week on average.

11. The method of claim 1, wherein the cat is the companion animal to a caregiver that is sedentary or disabled.

12. The method of claim 1, wherein the cat has a disability that diminishes the ability of regular physical exercise.

13. The method of claim 1, wherein after about 3 days on the high protein diet, the 12,13-diHOME blood level is increased compared to a baseline blood level for a full 24 hours per day.

14. The method of claim 1, wherein administering to the cat the high protein diet includes administering the high protein diet on daily consistent basis for a period of time of at least 1 week.
